(19) United States
(12) Patent Application Publication
(10) Pub. No.: US 2008/0316478 A1
(43) Pub. Date: Dec. 25, 2008

(54) METHOD AND APPARATUS FOR SPECTROMETER NOISE REDUCTION

(76) Inventors: Christopher SLAWINSKI, Mesa, AZ (US); James M. WELCH, Gilbert, AZ (US); N. Alan ABUL-HAJ, Mesa, AZ (US); Kevin H. HAZEN, Gilbert, AZ (US)

Correspondence Address: GLENN PATENT GROUP, 3475 EDISON WAY, SUITE L, MENLO PARK, CA, 94025, US

(21) Appl. No.: 12/125,021

(22) Filed: May 21, 2008

Related U.S. Application Data
(60) Provisional application No. 60/940,639, filed on May 29, 2007.

(51) Int. Cl. G01J 3/00

(52) U.S. Cl. 356/300

(57) ABSTRACT

Methods and apparatus for enhancing reference spectra are presented. Movement of a reference material relative to a spectrometer optical path is used to enhance reference spectra precision. Alternatively, changing an optically sampled area and/or volume of a reference material during collection of a reference spectrum is used to enhance reference spectra precision. Two separate cases are treated, where the observed variation removed is dependent upon hardware configuration of an analyzer and position of the analyzer relative to the reference. The first case is reduction or removal of radiance variation. The second case is reduction or removal of spectral variation due to observed diffraction. Enhanced reference spectra precision results in enhanced precision and/or accuracy of associated analyte property determinations.

### CROSS REFERENCE TO RELATED APPLICATIONS

This application claims benefit of U.S. provisional patent application Ser. No. 60/940,639, filed May 29, 2007, the entirety of which is incorporated herein by this reference thereto.

### BACKGROUND OF THE INVENTION

1. Field of the Invention

This invention relates generally to the reduction of spectrometer instrument noise. More particularly, a method and apparatus are presented for reducing spectrometer instrument noise via changing an optically sample volume of a reference material during reference spectrum collection.

2. Discussion of the Prior Art

Analyte property determination using an optical based analyzer typically requires collection of a reference spectrum of a reference material, where the reference material is repeatedly positioned and coupled relative to an optical interfacing element or sample probe.

### Problem

It is desirable to provide a means of assuring that a sample, such as a tissue sample volume containing an analyte of interest, is repeatedly sampled. Often, the optics required to optically sample a particular tissue depth must be very tightly configured and as such are not optimal for alternating sampling of a reference material and a sample. Reconfiguration of the optics for collection of the reference spectrum leads to degraded tissue spectra repeatability due to mechanical limitations of reproducibly reconfiguring the spectrometer optical train. Hence, static optics required for analysis of many samples, such as a noninvasive tissue measurement often leads to a degraded reference spectrum. It would be highly advantageous to provide a system that allows for optimal measurement of a tissue component that is additionally usable without reconfiguration for collection of a reference spectrum, where the associated reference spectrum does not degrade data processing and analyte property determination from the noninvasive spectrum.

### SUMMARY OF THE INVENTION

Methods and apparatus for enhancing reference spectra are presented. Relative movement of a reference material relative to a spectrometer optical path is used to enhance reference spectra precision. Alternatively, changing an optically sampled area and/or volume of a reference material during collection of a reference spectrum is used to enhance reference spectra precision. Two separate cases are treated, where the observed variation removed is dependent upon hardware configuration of an analyzer and position of the analyzer relative to the reference. The first case is reduction or removal of radiance variation. The second case is reduction or removal of spectral variation due to observed diffraction. Enhanced reference spectra precision results in enhanced precision and/or accuracy of associated analyte property determinations.

### DESCRIPTION OF THE FIGURES

FIG. 1 illustrates photon interaction with layered skin at a sample site;

FIG. 2 presents an analyzer comprising a base module, a sample module, and communication means;

FIG. 3 demonstrates reference spectra precision (A) with no reference movement and (B) with reference movement relative to an illumination area;

FIG. 4 illustrates reference material placement precision;

FIG. 5 presents reference spectra precision with reference placement;

FIG. 6 provide images of reference materials;

FIG. 7 show Fourier transformed intensities of reference materials;

FIG. 8 illustrates a sample probe illuminating a reference material; and

FIG. 9 shows optical path differences.

### DETAILED DESCRIPTION OF THE INVENTION

Movement of a reference material relative to a spectrometer optical path is used to enhance reference spectra precision. Alternatively, changing an optically sampled area and/or volume of a reference material during collection of a reference spectrum is used to enhance reference spectra precision. Two separate cases are treated, where the observed variation removed is dependent upon a hardware configuration of an analyzer. The first case is reduction or removal of radiance variation. The second case is reduction or removal of spectral variation due to observed diffraction. Enhanced reference spectra precision results in enhanced precision and/or accuracy of associated analyte property determinations.

Analyzers or spectrophotometers are described in more detail, infra. Generally, spectrometers typically use a reference material. Many types of spectrometers, such as a single beam spectrometer, require that the reference material is positioned relative to the optical path on a repeated basis. For example, the reference material is placed in the optical path periodically, daily, weekly, or prior to or after spectra are collected for each sample. Mechanical limitations prevent the reference material from being mechanically placed in exactly the same spot with each placement. Further, mechanical and physical limitations prevent the reference material from being perfectly homogenous. For example, there exist surface and/or volume anomalies in a reference material. Anomalies include chemical and physical inhomogeneities. As a result, an optical sampling of the reference material observes great variety in number and types of surface anomalies that manifest themselves in reference spectra in a non-uniform and highly unpredictable manner.

For example, in-vivo measurement of tissue properties or analyte concentration using optical based analyzers requires that both a reference material and a tissue measurement region be positioned and coupled with respect to an optical interface or probe, such as a tip of a sampling module or sample probe. Tight limitations on the measurement of a sample result in only a small region or volume of a standard reference being seen without a detrimental change in detection parameters, such as integration time. This results in reference spectra having radiance and/or diffraction based variation.

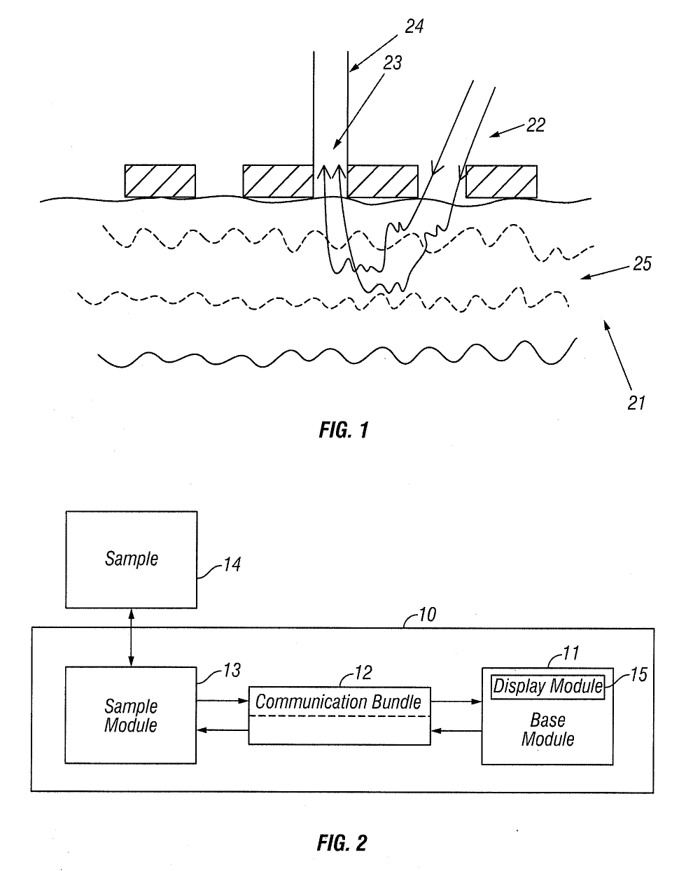

Referring now to FIG. 1, a skin sample 21 having multiple layers is used to illustrate the problem. Incident photons 22 from an analyzer 10 penetrate into the skin surface. In the near-infrared spectral region, such as from about 1100 to 1800 nm, the depth of photon penetration generally increases with increased radial distance from the point of a photon entering into the skin. Further, absorbance/scattering of near-infrared light results in decreased collected intensity at the skin surface with increased radial distance from the area of incident photons entering the skin. Hence, collected/observed photons 23, such as via a collection optic 24 or fiber optic are optimally collected a short distance from the region where incident photons enter the skin in order to achieve the maximal number of collected photons probing an analyte dense layer 25 of the tissue 21. Thus, near-infrared noninvasive glucose determination use a small sample spot size. Further, some optical measurements, such as a near-infrared based noninvasive glucose concentration measurement of skin, benefit from an optical system that is minimally adjusted between replicates. Thus, a noninvasive glucose analyzer is an example of a system using a small spot size that is not adjusted between samples. Therefore, the reference material should function with the small spot size used for the analyte determination. As described, supra, the small spot size is not ideally suited for sampling a reference material. The system taught herein minimizes the effect of the anomalies on the reference in conjunction with a small spot size by moving the reference material relative to the small spot size during data collection in order to average a larger area/volume of the reference material into reference spectra. This process is described further, infra.

In one embodiment, an analyzer is used. Referring now to FIG. 2, a block diagram of a spectroscopic analyzer 10 including a base module 11 and sample module 13 connected via communication means 12, such as a communication bundle is presented. The analyzer preferably has a display module 15 integrated into the analyzer 10 or base module 11. For example, the analyzer is a glucose concentration analyzer that comprises at least a source, a sample interface, at least one detector, a reference material, and an associated algorithm. The base module, communication bundle, and sample module are optionally integrated into a single unit, such as a handheld unit.

Ideally, a reference material is prepared with enhanced homogeneity. However, increased reference material homogeneity:
is difficult to achieve over a large reference surface area or volume;
is difficult to maintain through time;
is complex to reproduce between batches or between reference standards; and
increases reference material cost.

In practice, no ideal reference material exists. As a result, variation in reference spectra need to be minimized using other means. Two types of variation are removed by moving a reference material during collection of a reference spectrum. The first radiance case and second case of spectral variation due to observed diffraction are each described, infra.

### Radiance Variation and Spectral Variation Due to Diffraction

In a general sense, radiance is a measure of the optical power leaving a source that is collected by a detector.

In a case of a sample probe collecting light from an illuminated reference material, the radiance from each infinitesimal element of the reference material that is collected by the detection fiber depends on the element's angle relative to the reference normal, the element's distance from the detection fiber, and on how well it is illuminated. If the reference material changes its position relative to the detection fiber, then the total amount of power collected by one or more detection fibers changes because the radiance from the reference material is different. Here, the variation of collected power due to radiance variation is referred to as radiance variation. Intentionally moving the reference material relative to the sample probe averages the variations and produces a more uniform and less varying signal. This happens because both the illumination pattern on the reference material and the radiance collected by the sample probe are averaged.

Another type of variation in the light collected from a reference material appears as spectral variations due to diffraction from features in the reference material. In this case, the diffraction leads to higher detected optical intensities at wavelengths where constructive interference occurs and to lower intensities at wavelengths of destructive interference. Intentionally moving the reference material relative to the sample probe destroys the interferences and yields a more uniform signal.

Some motions of the reference material relative to the sample probe do not simultaneously eliminate both the effects of radiance variations and spectral variations. For example, if the reference material has a circularly symmetric feature pattern, and if it is spun about its center, then one of the effects may be reduced or eliminated and the other may not be. Which effect is reduced or eliminated depends on the specific geometries of the reference features, the probe, the probe reference separation, and the type of motion. One analogy is the colored bands seen in a compact disc for music and data storage. The bands do not disappear when the disc is rotated while viewing it nearly normally as the colored bands are the result of diffraction. However, when the disc is viewed at a steep angle, the diffraction disappears, leaving the potential for radiance variations, caused by illumination variations or by surface irregularities, to persist.

Small motions relative to large reference material features have similar confounding effects. If the reference material features are linear, and if the motion is parallel to the features, then it is possible that the radiance variations are eliminated, while the spectral variations persist. Alternatively, if the reference material features are linear, and if the motion is perpendicular to the features, then it is possible that the radiance variations persist while the spectral variations are instead eliminated. In general, specific motions are used to reduce or eliminate either the radiance or spectral variation effects of features in the reference material or of the illumination irregularities on the reference material.

Here, the term, geometries, refers to the dimensions, angles, relative positions, and orientations of the components in the device.

### EXAMPLE I

Reference spectra collected using a noninvasive glucose concentration analyzer with and without movement during sampling are compared. For a fixed instrument configuration, reference spectra of a 99% Spectralon (Labsphere, North Sutton, N.H.), material were collected over a range of about 1200 to 1800 nm. A first set of ten spectra were collected with the reference placed in a static position during scanning. The reference material was removed and replaced between replicate measurements to simulate use. A second set of ten spectra were collected while the reference material was moving, The reference was spun during data collection.

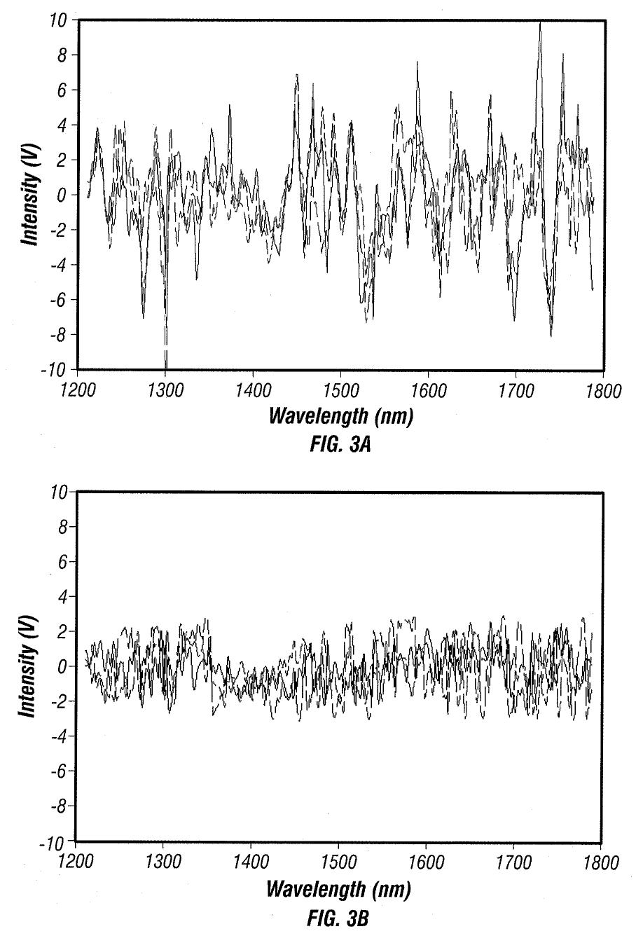

Referring now to FIG. 3, the first three spectra of the statically positioned reference are presented in FIG. 3A and the first three moving spectra of the moving reference are presented in FIG. 3B. First, the statically positioned reference spectra are observed to have higher noise than the moving reference spectra. The average standard deviation for the rotating reference spectra is 0.94V and increases 159% to 2.43 V for the spectra of the static reference spectra. Thus, moving the reference during data collection results in a decreased noise level observed on the standard, which yields lower errors on subsequent analyte analysis. Second, the statically positioned reference spectra are observed to have spectral shapes that vary in both wavelength position and in frequency of response. These shapes are absent in the spun spectra. The spectral features of the static reference spectra degrade analytical precision and accuracy of subsequently determined analyte properties. Third, the static reference spectra are observed to have at least two placements in terms of observed intensities.

A set of twelve noninvasive spectra of a human forearm collected immediately after the static and moving reference spectra described in the preceding paragraph were analyzed to determine glucose concentrations. The noninvasive spectra were analyzed twice, once with each set of reference spectra. Versus invasively determined reference glucose concentration values, the standard error of prediction of the noninvasively determined glucose concentrations fell 46.4% from 72.2 mg/dL using the static reference spectra to 38.7 mg/dL using the moving reference spectra. This demonstrates the efficacy of using a moving reference during reference spectra collection to reduce sample analyte property estimation error.

This example demonstrates that spatially averaging the detected light specularly and/or diffusely reflected from a reference material during data collection, such as by spinning or moving the reference, effectively reduces or eliminates constructive and destructive interferences observed as spectral peaks and valleys.

For some applications, an analyzer is beneficially configured or optimized with a optically small sample site area/volume. Often this has to do with the sample itself. For example, a sample may have spatial variation and/or layers that require a specific optical system or the probing photons may have absorbance/scattering properties that dictate a small sample volume. Herein, a specific example of a noninvasive glucose analyzer optically sampling skin tissue is used to illustrate these points. However, the invention is more generally applied to collection of reference spectra with relative movement of a reference material to an analyzer optical path.

### Spatial Variation

One case is to reduce observed radiance variation or reference intensity offsets occurring across many or all wavelengths as a result of imprecise positional alignment of an analyzer relative to a reference material. For instance, movement of a reference material during sampling results in spectra sampling many regions of a reference material, thereby reducing the effect of individual anomalous physical features of a reference, such as dark regions on a light reference, valleys or peaks on the surface of a flat reference, non-reflective zones on a reflective standard, voids in a reference material, variation in granular size with position on a reference, and facets resulting in non-uniform reflection of light from a reference, all of which are referred to in the art salt and pepper or as pepper imperfections on a salt reference. In another instance, movement of the reference during collection of a reference spectrum minimizes or eliminates instrument design errors, such as non-uniformly illuminated regions of a reference material relative to uniformly illuminated regions of a reference material.

Typically, a reference material contains a multitude of anomalies or facets, as described supra. Each anomaly individually affects a resultant observed signal. For instance, at a given wavelength one anomaly may increase observed intensity while another wavelength will decrease in observed intensity. Hence, a larger incident cross-sectional area and larger optically observed collection area result in a reference spectrum with a large number of anomalies being summed into a resultant signal. As some anomalies increase intensity and others decrease observed intensity, a reference spectrum from a larger sampled area/volume of the reference material yields reasonably reproducible reference spectra as the effect of the anomalies average. However, both the enhanced homogeneity approach and the larger optical sample size approach fail when there exists a requirement for a relatively small sampled area or volume, such as in a near-infrared based noninvasive glucose concentration determination or when using one, two, or three light collection fibers.

### Effect of Reference Anomalies

Generally, with a small number of reference material anomalies in the optical path, a change in reference signal is observed with movement of the optical illumination area on the reference material. For example, on one reference scan six anomalies may be observed while seven anomalies may be observed in a subsequent reference spectrum. This results in a change in reference signal. These changes are often measured at the micro-volt level. Since changes are observed as an integral single value reading, the spatial information of the reference material is lost and the signal may be misinterpreted as a change in the observed measured analytical sample signal. In practice, a step function effect on the observed reference intensity is observed, which can dramatically change an absorption calculation for the sample. The absorption change results in an error in the determined analyte property. This is especially true on determinations made near a signal-to-noise ratio limit or for trace analysis.

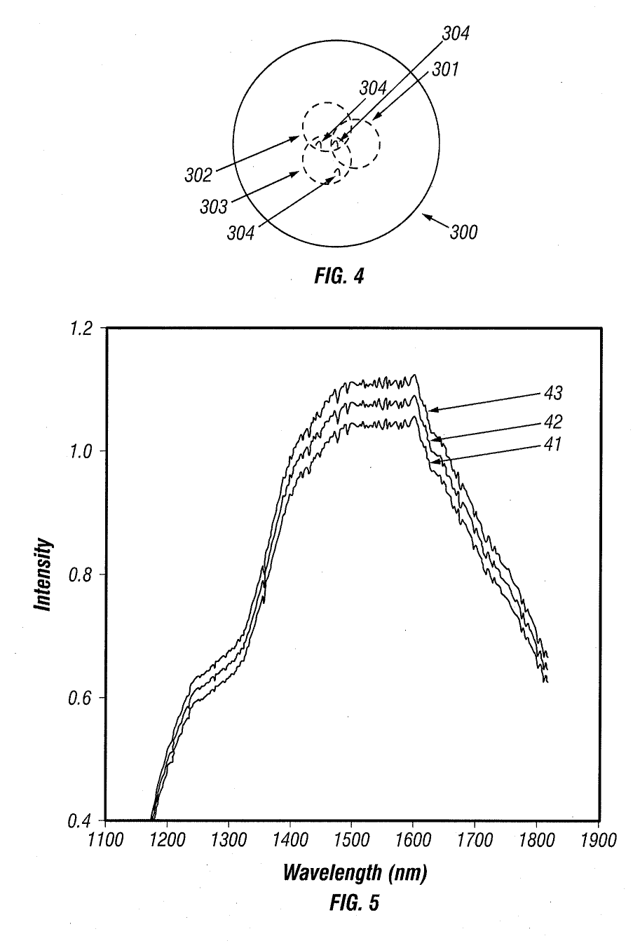

In one illustrative example, particular anomalous features of a reference material are observed spectrally by the spectrometer. Referring now to FIGS. 4 and 5, an illustrative example is provided to show the effect of surface feature anomalies on collected reference spectra where the sampling spot on the reference fractionally varies with reference sample placement.

Referring now to FIG. 4, a surface of a reference material 300 is illustrated with reference anomalies 304, such as a surface anomaly or a volume anomaly of the reference material. Typically, a reference material is removed and replaced, such as once a day or with each sample. Mechanical limitations prevent perfect placement of the reference material with each sample. As such, the illuminated area of the surface of the reference varies with each placement. Three illumination areas are illustrated 301-303. In FIG. 4, the first, second, and third illumination areas 301, 302, and 303, overlap one, two, and three reference anomalies, respectively.

Referring now to FIG. 5, three reference spectra are presented 41, 42, 43 that correspond to the three reference illumination areas presented in FIG. 4. In this example, the reference spectrum corresponding to the sample area having one reference anomaly has the lowest reference spectrum intensity and the reference spectrum corresponding to the sample area having three reference anomalies has the highest reference spectrum intensity. Thus, the example of FIGS. 4 and 5 shows that small variation in placement of a small sample illumination area/volume on a reference material having surface anomalies results in varying reference spectra intensity and with little or inconsequential change in spectra shape.

### Spectral Variation due to Diffraction

In a second case, a more thorough explanation of constructive and destructive interferences observed as spectral peaks and valleys is described where spatially averaging the detected specularly and/or diffusely reflected light from a reference material during data collection reduces the observed interferences resulting from diffraction. Diffractions results in reference spectra having variation in shape, while average observed intensity change off of a reference is small.

### Analysis of Reference Material Surface Features

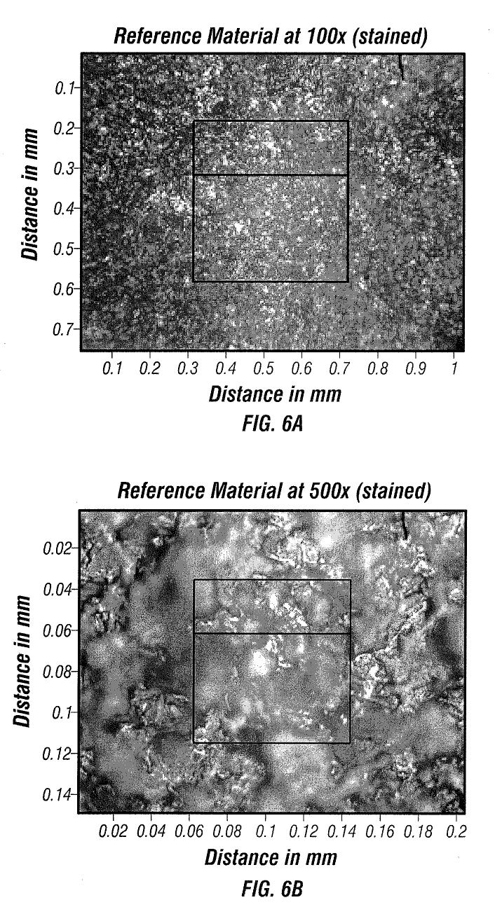

Referring now to FIG. 6, photomicrographs of a stained 99% diffuse reflectance reference material, in this case a Spectralon reference, at 100×, FIG. 6A, and at 500×, FIG. 6B, magnification show structure. Since the structure is three-dimensional and since the microscope's depth of focus is very small, not all parts of the surface features are in focus.

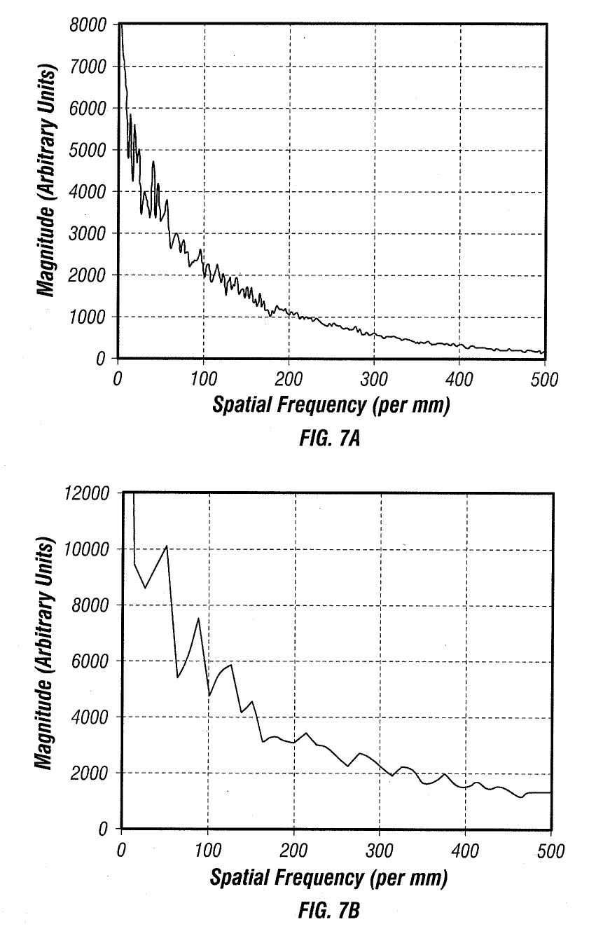

Fourier transforms of the image intensities in FIG. 6 suggest structure sizes for the reference material. FIGS. 7A and 7B show the mean of the Fourier transforms for the pixels along the rows in the small black boxes in FIG. 6. The general shape of the plot suggests that there is a broad distribution of spatial frequencies in the reference material. Peaks appear at spatial frequencies of approximately 50 per mm. This suggests that the reference material has a concentration of surface structures on the order of 1/50 millimeter or about 0.02 mm.

### Mechanism for the Diffraction Effect

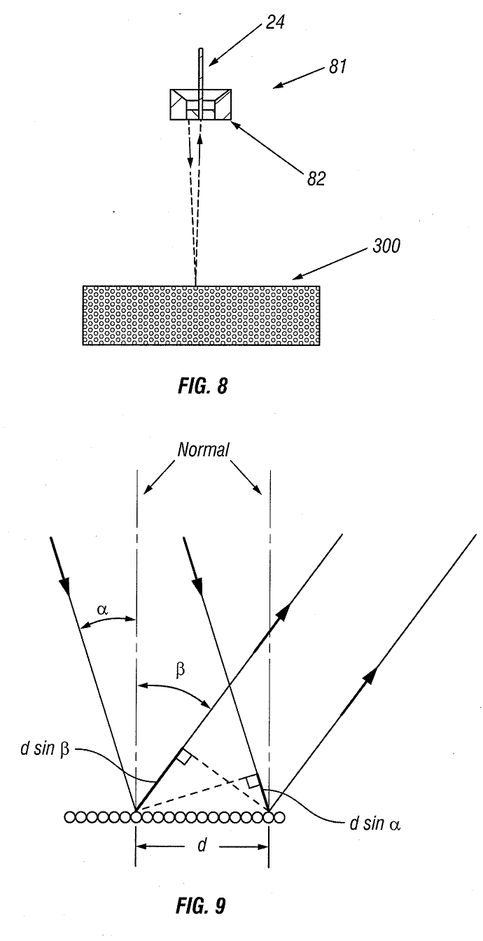

Referring now to FIG. 8, in normal operation, the sample probe 81 of a sample module 13 illuminates the reference material 300. Some of the illumination light that is reflected, scattered and diffracted from the reference material is then collected by one or more detection fibers 24 at about the center of the sample probe. The majority of the light is diffusely scattered from the reference material. A small fraction of the light is diffracted by the features on the surface of the reference material. Diffraction produces constructive and destructive interference amongst light rays with slightly different paths. Constructive interference produces a higher light intensity at the point where the rays are detected, such as at the tip of the detection fiber 82. Destructive interference produces a low intensity or no intensity at all. Two light rays constructively interfere when their optical paths differ by an integral number of wavelengths. Destructive interference results when the optical path difference is one half wavelength off from an integral number of wavelengths.

The optical path difference (OPD) between two rays en route from a common source to a common detector, is the difference in the distance they travel times the index of refraction of the medium in which they travel. In air the index of refraction is close enough to one that it is ignored. Referring to FIG. 9, two rays that originate from the same point on the sample probe source, reflect from features on the reference material, and are collected by the detection fiber for processing by the spectrometer, have an optical path difference, OPD, of:

OPD=d(sin α−sin β) eq. 1

The optical path difference will give rise to constructive interferences when the rays travel an integral number of wavelengths, as shown by:

OPD=d(sin α−sin β)=mλ eq. 2

where m is an integer and A is wavelength. Similarly, destructive interference results when the optical path difference is off of an integral number of wavelengths by one half wavelength. That is, destructive interference occurs when:

OPD=d(sin α−sin β)=(m+½)λ eq. 3

### Coherence Length and Optical Path Difference

For diffraction to occur between two rays that come from a common source, the coherence length of the source must be longer than the optical path difference between the two rays.

Here, coherence length is the distance over which the phase relationships among waves remain the same or nearly the same. Coherence length is a property of the source and is estimated by:

$${L}_{c} = \frac{{λ}^{2}}{2 π Δ λ} \qquad eq . 4$$

where, λ is the wavelength of the light, and Δλ is its bandwidth.

### Comparison of Coherence Length to OPD for the Sample Probe and Reference Material

For the case of the sample probe and reference material, a comparison of the estimated coherence length and the estimated optical path difference reveals that optical coherence is maintained over long enough distances to allow interference. This is shown by computing the coherence length for the sample probe source and the optical path difference for typical rays collected from the reference material.

Since the light that is diffracted from the reference material is processed by the spectrometer, the source's bandwidth, change in wavelength (Δλ), is reduced to that of the spectrometer, in this example the bandwidth is about 12 nm. A typical wavelength for the near infrared spectrum is 1500 nm. Then, the coherence length, L_{c}, of the diffracting light is,

L_{c}=(1500 nm)²/(2π12 nm)=0.03 mm eq. 5

The geometry of the sample probe, as suggested in FIGS. 8 and 9, leads to typical angles of α and β that are about 0, 1, 2, 3, 4 or 5 degrees of arc. These are only typical and not specific because many ray paths are present and that lead to diffraction. This calculation suggests a typical extreme optical path difference between two typical rays diffracting from features 0.02 mm apart is computed by assuming one angle is on the high end of typical (5°) and the other is on the low end (0°):

OPD=(0.02 mm)(sin 5°−sin 0°)=0.02 mm eq. 6

The conclusion is the optical path difference between rays diffracting from spatial features on the reference material, in this extreme example, 0.02 mm, is indeed less than the coherence length of the source as processed by the spectrometer, 0.03 mm, a condition necessary for diffraction to occur.

From this it is understood that spinning a reference material for a reference material composed of small particle sizes reduces and/or eliminates changes in intensity resulting from diffraction, as illustrated in FIGS. 5A and 5B as diffraction patterns observed at each instant in time are changing due to movement of the reference material relative to the optical path and the collected signals integrated.

### EXAMPLE II

Human tissue dictates an optimal sample probe geometry that complicates collection of reference spectra from references having small particle sizes.

### Human Tissue

When incident light is directed onto a skin surface, a part of the incident light is reflected while the remaining part penetrates the skin surface. The penetrating light is absorbed and/or scattered. The scattered light redirects and is distributed both radially and through a depth. For a given analyte determination, control of the photonically sampled tissue volume in terms of depth and radial distribution is important. Ideally light is controlled into an analyte rich layer. For a noninvasive glucose example, light is preferably maintained in a dermal skin layer rich is glucose and light is preferably restricted from a subcutaneous fat layer largely devoid of glucose. A combination of incident light controlling optics and light collection optics defines the sampled tissue volume. Using the defined combination, optics are created that complicate reference spectra collection.

### Reference Spectra

The inventors have realized optics optimized for a given analyte determination in a tissue sample lead to imprecise measurements of a reference material. For noninvasive glucose determination, a small incident spot size about one or a few collection optics results in proper distribution of light in a sampled skin tissue. However, use of the same optical system on a reference material means that a small incident spot size and small optically observed detection volume is used on the utilized reference material. As a result of the tight incident and collected optics, small reference anomalies affect collected reference signals. Failure to control reference spectra precision detrimentally effects analyte determination from associated sample spectra. Thus, spectrometer optics optimized for a sample lead to imprecise reference spectra. Control of the reference spectra becomes necessary.

The inventors have determined that movement of the reference material relative to the spectrometer optical path yields reference spectra with enhanced precision, resulting in more precise and/or accurate analyte property determination.

### EXAMPLE III

Additional reference material anomalies lead to changes in intensity when observed with optics having limited field of view. These additional anomaly types are described here. For each type of anomaly, movement of the reference relative to the sample probe tip during reference spectra collection reduces and/or eliminates radiance effects or changes in intensity resulting from diffraction.

Chemical and physical processes prevent a reference material from being perfectly uniform and homogenous. Hence, different surface areas or optically sampled volumes of the reference material yield fractionally different responses. Many forms of reference material anomalies exist. A few examples include:
a surface anomaly, such as:
   an inverted cone of material over a small region of the surface of the reference material;
   curvature of the surface; and
a volume anomaly, such as
   a localized rarification of reference material;
   a non-homogenous volume; and
swelling of the material due to contamination, temperature fluxuations, and/or change in humidity.

If the utilized analyzer cannot be used with a sufficient illumination or surface area, then in order to minimize reference spectra noise the reference must be reproducibly positioned, the reference must have a limited number of imperfections, or the reference spectra must be collected in a manner to minimize the effect of the imperfections, such as with relative movement of the reference material relative to the optical train of the analyzer.

### Relative Movement of Analyzer Optical Path and Reference Material

Movement of the reference standard material relative to the analyzer sampling area reduces dependence on position, orientation, and particle size in the reference material. Movement of the illumination/detection areas of the analyzer and/or movement of the reference material yields the relative movement. Herein movement of the reference may also refer to relative movement of the reference material relative to the analyzer optics. Movement of the reference material:
results in a larger samples area/volume of the reference material;
increases the number of individual anomalies observed;
increases the number of angles that the probing light interacts with a given anomaly; and/or
reduces effects of diffraction.

Similarly, as the angular distribution of returned light is a function of the specific area of the reference illuminated and angle of incident light hitting the illuminated area, change in position of the reference along the x- or y-axis as well as rotational placement of the reference material yield a change the resultant signal.

A net result of movement of the reference is to yield an average response that is more repeatable in terms of accuracy and especially in terms of precision.

Movement of the reference material is achieved in a number of ways not limited to:
spinning or rotating the reference along an axis;
rotating the reference material off axis;
linearly moving the reference material;
movement of the reference material along an optical z-axis; and
wobbling the reference material.

Alternatively, the optical system is optionally altered yielding an apparent movement of the reference standard. Examples of analyzer alteration to average anomaly effect include but are not limited to:
focusing and/or defocusing an illumination or collection optic; and
altering an illumination optic and/or detection optic.

Movement of the reference material is generally applicable to a diffuse reflectance standard containing surface and/or internal reference material volume anomalies. Although different, the method is also applicable to transmission standards.

The system of relative movement of the optical path versus the reference material position applies to any shape, volume, or tilt of the reference. For example, instead of spinning the reference material, the tilt of a face of the reference material relative to the sample probe tip is altered during reference spectra collection.

Notably, the method of using a moving apparatus to provide movement of a reference material relative to the analyzer separates instrument reference error from sampling error. The method of moving the reference material defines and removes a source of instrument error.

It is further noted that movement of a reference material is distinct from movement of a sample during data collection. For example, agricultural samples, such as wheat, are rotated during data collection. This method of averaging with samples is used for grossly rough or uneven materials, such as whole wheat or seeds, and yield an average collected light. The art has not been applied to minimize error associated with placement and minute surface roughness associated with a reference to enhance performance of the instrument.

### EXAMPLE IV

In addition, reference materials:
change as a function of time;
vary between reference standards;
are difficult to compare given multiple points of use on the globe;
have production methods that vary in relative purity; and
are not reproducible.

Movement of the reference material relative to a sampled optical area during collection of the reference spectra enhances precision of collected reference spectra mitigating at least one of these issues.

### EXAMPLE V

An example of using non-uniform illumination in conjunction with a noninvasive glucose concentration determination is provided. An analyzer having a filament source and a backreflector yields an image at a focal distance. Preferably, the skin sample is located near the focal distance for optimal photon throughput. Further, it is preferable to keep the illumination spot size small so that radial travel of light in the skin tissue is minimized while still allowing the photons to sample dermal depths in the tissue. The smaller radial travel from the illumination area to the optical collection area preferentially samples dermal layers while reducing interference resulting from sampling subcutaneous fat layers. Still further, it is beneficial to use a low power source so as not to heat the skin tissue. The net result is that the filament is observed spectrally. The system used in yields the filament being observed in terms of tilt, lack of centering relative to the reflector, observation of individual filament coils so that hot an cold area of the source are observed. These non-uniform illuminations are tolerable in the tissue sample, but lead to errors when optically sampling the reference having surface and/or volume anomalies, as described supra.

### Analyzer

Optional analyzer components and configurations are described, herein.

### Instrumentation

A spectrometer has one or more beam paths from a source to a detector. Optional light sources include a blackbody source, a tungsten-halogen source, one or more light emitting diodes, or one or more laser diodes. For multi-wavelength spectrometers a wavelength selection device is optionally used or a series of optical filters are optionally used for wavelength selection. Wavelength selection devices include dispersive elements, such as one or more plane, concave, ruled, or holographic grating.

Conventionally, all of the components of a noninvasive glucose analyzer are included in a single unit. Herein, the combined base module 11, communication bundle 12, sample module 13, and processing center are referred to as a spectrometer and/or analyzer 10. Preferably, the analyzer 10 is physically separated into elements including a base module in a first housing 11, a communication bundle 12, and a sample module in a second housing 13. Advantages of separate units include heat, size, and weight management. For example, a separated base module allows for support of the bulk of the analyzer on a stable surface, such as a tabletop or floor. This allows a smaller sample module to interface with a sample, such as human skin tissue. Separation allows a more flexible and/or lighter sample module for use in sampling by an individual. Additionally, separate housing requirements are achievable for the base module and sample module in terms of power, weight, and thermal management. In addition, a split analyzer results in less of a physical impact, in terms of mass and/or tissue displacement, on the sample site by the sample module. The sample module, base module, communication bundle, display module, and processing center are further described, infra. Optionally, the base module 11, communication bundle 12, and sample module 13 are integrated into a single unit.

### Sample Module

A sample module 13, also referred to as a sampling module, interfaces with a tissue sample at a sample site, which is also referred to as a sampling site. The sample module also interface with a reference material. Typically, the sample module interfaces with the sample at one point in time and with the reference material at a second point in time. The sample module includes a sensor head assembly that provides an interface between a glucose concentration tracking system and the patient. The tip of the sample probe of the sample module is brought into contact or proximate contact with the tissue sample. Optionally, the tip of the sample probe is interfaced to a guide, such as an arm-mounted guide, to conduct data collection and removed when the process is complete. An optional guide accessory includes an occlusion plug that is used to fill the guide cavity when the sensor head is not inserted in the guide, and/or to provide photo-stimulation for circulation enhancement. In one example, the following components are included in the sample module sensor head assembly: a light source delivery element, a light collection optic and an optional fluid delivery channel from a reservoir through a portion of the sample probe head to the sample probe head skin contact surface. Preferably, the sample module is in a separate housing from the base module. Alternatively, the sample module is integrated into a single unit with the base module, such as in a handheld or desktop analyzer. The sample module optionally has a pressure sensor generating a charge and corresponding voltage indicative of contact pressure. For example, a film with air voids internally contained results in different capacitive charges being measured between film layers as the layers are pressed together, as a measure of pressure on the probe tip surface. An example is an Emfit film (Emfit Ltd, Finland).

### Communication Bundle

A communication bundle 12 is preferably a multi-purpose bundle. The multi-purpose bundle is a flexible sheath that includes at least one of:
electrical wires to supply operating power to the lamp in the light source;
thermistor wires;
one or more fiber-optics, which direct diffusely reflected near-infrared light to the spectrograph;
a tube, used to transport coupling fluid and/or optical coupling fluid from the base unit, through the sensor head, and onto the measurement site;
a tension member to remove loads on the wiring and fiber-optic strand and/or to moderate sudden movements; and
photo sensor wires.

Further, in the case of a split analyzer the communication bundle allows separation of the mass of the base module from the sample module. In another embodiment, the communication bundle is in the form of wireless communication. In this embodiment, the communication bundle includes a transmitter, transceiver, and/or a receiver that are mounted into the base module and/or sample module.

### Base Module

A portion of the diffusely reflected light from the sample site is collected and transferred via at least one fiber-optic, free space optics, or an optical pathway to the base module. For example, a base module contains a spectrograph. The spectrograph separates the spectral components of the diffusely reflected light, which are then directed to a photo-diode array (PDA). The PDA converts the sampled light into a corresponding analog electrical signal, which is then conditioned by the analog front-end circuitry. The analog electrical signals are converted into their digital equivalents by the analog circuitry. The digital data is then sent to the digital circuitry where it is checked for validity, processed, and stored in non-volatile memory. Optionally, the processed results are recalled when the session is complete and after additional processing the individual glucose concentrations are available for display or transfer to a personal computer. The base module also, preferably, includes a central processing unit or equivalent for storage of data and/or routines, such as one or more calibration models or net analyte signals. In an optional embodiment, a base module includes one or more detectors used in combination with a wavelength selection device, such as a set of filters, Hadamard mask, and/or a movable grating.

### Display Module

A noninvasive glucose concentration analyzer preferably contains a display module 15 that provides information to the end user or professional. Preferably, the display module 15 is integrated into the base module 11. Optionally, the display module is integrated into the sample module 13 or analyzer 10. The display screen communicates current and/or historical analyte concentrations to a user and/or medical professional in a format that facilitates information uptake from underlying data. A particular example of a display module is a 3.5″ ¼ VGA 320×240 pixel screen. The display screen is optionally a color screen, a touch screen, a backlit screen, or is a light emitting diode backlit screen.

### Reference Module

A reference module holds the reference material relative to the sample probe. The reference module is optionally physically separated from the analyzer or is integrated into the analyzer. Typically, the reference module replaceably interfaces with an end of the sample probe. In one embodiment, a portion of the optical train is moved relative to the reference material. For example, a tip of a fiber optic of the sample module is moved into a position relative to the reference material. In a second embodiment, the entire optical train of the analyzer is maintained in a fixed relative configuration. The entire optical train of the analyzer is moved such that the optical sampling portion of the analyzer samples the reference material. Movement of the entire spectrometer optical train further reduces instrument noise, such as noises associated with motor noises, imprecision of precisely and accurately positioning one or more optical components relative to other optical components in the analyzer, or removal of noise associated with fiber optic stress/strain, or noise resulting from wear of analyzer components required for movement of one or more optics relative to other optics in the analyzer.

Those skilled in the art will recognize that the present invention may be manifested in a variety of forms other than the specific embodiments described and contemplated herein. Departures in form and detail may be made without departing from the spirit and scope of the present invention. Accordingly, the invention should only be limited by the Claims included below.

1. An apparatus for reducing noise in a reference spectrum, comprising:
a single beam optical analyzer having an optical coherence length and comprising a sample probe tip;
a reference material; and
means for changing an optically observed volume of said reference material during collection of a reference spectrum.

2. The apparatus of claim 1, wherein a first photon comprises a substantially normal first path from said sample probe tip, to said reference material, and back to said sample probe tip, wherein a second photon comprises a second path from said sample probe tip, to said reference material, and back to said sample probe tip, wherein said second path is along an outer limit of a numerical aperture observed by said sample probe tip, wherein a pathlength difference is the difference between said first path and said second path, wherein said pathlength difference is less than said optical coherence length.

3. The apparatus of claim 1, wherein said reference spectrum exhibits radiance variation manifested as change in intensity of repeated collection of said reference spectrum with removal and replacement of said reference material from a beam of said analyzer.

4. The apparatus of claim 2, wherein said reference spectrum exhibits variation in spectral shape due to observed diffraction from said reference material with removal and replacement of said reference material into a beam of said analyzer.

5. The apparatus of claim 4, wherein said reference material comprises a concentration of surface structures on the order of about 0.02 millimeters in cross-sectional area.

6. The apparatus of claim 1, wherein said means for changing said optically observed volume of said reference material comprises spinning said reference material during collection of said reference spectrum.

7. The apparatus of claim 1, wherein said means for changing said optically observed volume of said reference material comprises translating said sample probe tip relative to reference material, wherein said reference material is spatially fixed in space during collection of said reference spectrum.

8. The apparatus of claim 1, wherein said means for changing said optically observed volume of said reference material comprises translating, along a plane substantially parallel to a plane defined by said sample probe tip, said reference material relative to said sample probe tip, wherein said sample probe tip is spatially fixed in space during collection of said reference spectrum.

9. The apparatus of claim 1, wherein said means for changing said optically observed volume of said reference material comprises rotating said reference material relative to said sample probe tip, wherein said sample probe tip is spatially fixed in space during collection of said reference spectrum.

10. The apparatus of claim 1, wherein said means for changing said optically observed volume of said reference material comprises tilting an outer face of said reference material relative to said sample probe tip, wherein said sample probe tip is spatially fixed in space during collection of said reference spectrum.

11. The apparatus of claim 1, wherein said means for changing said optically observed volume of said reference material comprises changing optical focus of said analyzer by moving one or both of a filament of a source of said analyzer or a shape of a backreflector of said analyzer during collection of said reference spectrum.

12. The apparatus of claim 1, wherein said analyzer comprises a noninvasive glucose concentration analyzer having a single optical collection fiber.

13. A method for reducing noise in a reference spectrum, comprising the steps of:
collecting a reference spectrum of a reference material using a single beam optical analyzer having an optical coherence length and comprising a sample probe tip; and
changing an optically observed volume of said reference material during collection of said reference spectrum.

14. The method of claim 13, wherein a first photon comprises about a substantially normal first path from said sample probe tip, to said reference material, and back to said sample probe tip, wherein a second photon comprises a second path from said sample probe tip, to said reference material, and back to said sample probe tip, wherein said second path is along an outer limit of a numerical aperture observed by said sample probe tip, wherein a pathlength difference is the difference between said first path and said second path, wherein said pathlength difference is less than said optical coherence length.

15. The method of claim 13, wherein said reference spectrum exhibits radiance variation manifested as change in intensity of repeated collection of said reference spectrum with removal and replacement of said reference material from a beam of said analyzer.

16. The method of claim 14, wherein said reference spectrum exhibits variation in spectral shape due to observed diffraction from said reference material with removal and replacement of said reference material into a beam of said analyzer.

17. The method of claim 16, wherein said reference material comprises a concentration of surface structures on the order of about 0.02 millimeters in cross-sectional area.

18. The method of claim 13, wherein said step of changing said optically observed volume of said reference material further comprises a step of:
spinning said reference material during collection of said reference spectrum.

19. The method of claim 13, wherein said step of changing said optically observed volume of said reference material further comprises a step of:
translating said sample probe tip relative to reference material, wherein said reference material is spatially fixed in space during collection of said reference spectrum.

20. The method of claim 13, wherein said step of changing said optically observed volume of said reference material comprises translating, along a plane substantially parallel to a plane defined by said sample probe tip, said reference material relative to said sample probe tip, wherein said sample probe tip is spatially fixed in space during collection of said reference spectrum.

21. The method of claim 13, wherein said step of changing said optically observed volume of said reference material comprises rotating said reference material relative to said sample probe tip, wherein said sample probe tip is spatially fixed in space during collection of said reference spectrum.

22. The method of claim 13, wherein said step of changing said optically observed volume of said reference material comprises tilting an outer face of said reference material relative to said sample probe tip, wherein said sample probe tip is spatially fixed in space during collection of said reference spectrum.

23. The method of claim 13, wherein said step of changing said optically observed volume of said reference material comprises changing optical focus of said analyzer by moving one or both of a filament of a source of said analyzer or a shape of a backreflector of said analyzer during collection of said reference spectrum.

24. The method of claim 13, wherein said analyzer comprises a noninvasive glucose concentration analyzer having a single optical collection fiber.
